(19) United States
(12) Patent Application Publication
(10) Pub. No.: US 2016/0059710 A1
(43) Pub. Date: Mar. 3, 2016

(54) ELECTRIC DRIVE SYSTEM FOR MINING HAUL TRUCK

(71) Applicant: SIEMENS INDUSTRY, INC., ALPHARETTA, GA (US)

(72) Inventors: Kimberly Richey, Lilburn, GA (US); Xiaobin Wang, Cumming, GA (US)

(21) Appl. No.: 14/473,075

(22) Filed: Aug. 29, 2014

(51) Int. Cl. B60L 11/08

(52) U.S. Cl. CPC B60L 11/08

(57) ABSTRACT

An electric drive system for a vehicle includes a first generator in communication with a first engine, a second generator in communication with a second engine, a first rectifier and a second rectifier. Each generator has a main winding, each main winding being independently excitable and generating an alternating current (AC) output. A main AC output of the main winding of the first generator is in communication with the first rectifier, and a main AC output of the main winding of the second generator is in communication with the second rectifier. When in drive mode, the first engine drives the first generator and the second engine drives the second generator, and the first and second generators supply power to a plurality of inverters coupled to the first and second rectifiers, the plurality of inverts supplying power to a plurality of electric wheel motors.

### BACKGROUND

1. Field

Aspects of the present invention relate to power systems for a vehicle, and more particularly to electric drive systems for a vehicle, for example a mining haul truck, and a method for providing electrical power for a vehicle, for example a mining haul truck.

2. Description of the Related Art

Vehicles used in the mining industry such as for example mining haul trucks, electric shovels, and draglines are often driven by high-powered electrical motors. In some applications, electrical power is supplied to the electrical motors from an external power station via a feed cable or trolley line. In other applications, electrical power is supplied to the electrical motors from a generator on board the vehicle; the generator can be driven, for example, by a diesel engine.

Traditionally, mining truck applications only use one diesel engine and one generator or alternator. But one engine and one generator may not be capable to produce enough power required for certain applications. An improved electric drive system for off-highway vehicles is desired.

### SUMMARY

Briefly described, aspects of the present invention relate to electric drive systems for a vehicle, for example an off-highway vehicle and methods of providing electric power for an off-highway vehicle, the vehicle being for example a mining haul truck, in particular a dump truck.

A first aspect of the present invention provides an electric drive system for a vehicle comprising a first generator in communication with a first engine, a second generator in communication with a second engine, and a first rectifier and a second rectifier. Each generator comprises a main winding, and each main winding is independently excitable and generating an alternating current (AC) output. A main AC output of the main winding of the first generator is in communication with the first rectifier, and a main AC output of the main winding of the second generator is in communication with the second rectifier. When in drive mode, the first engine drives the first generator and the second engine drives the second generator, and the first and second generators supply power to a plurality of inverters coupled to the first and second rectifiers, the plurality of inverts supplying power to a plurality of electric wheel motors.

A second aspect of the present invention provides a method for providing electric power for a vehicle. Electric power is supplied by at least two generators to at least four electric wheel motors, the at least two generators being in communication with at least two engines, wherein the electric power is supplied from a plurality of inverters for at least four electric wheel motors via at least two rectifiers, the at least two rectifiers being operably connected to the at least two generators.

A third aspect of the present invention provides an electric drive system comprising a first engine coupled to a first alternator, wherein the first alternator generates a first output and a second output, a second engine coupled to a second alternator, wherein the second alternator generates a third output and a fourth output, a first main rectifier operably connected to the first output of the first alternator, a first auxiliary rectifier operably connected to the second output of the first alternator, a second main rectifier operably connected to the third output of the second alternator, and a second auxiliary rectifier operably connected to the fourth output of the second alternator.

The first and second main rectifiers each generate a direct current (DC) output, and both DC outputs of the main rectifiers are connected to a main DC bus. The first and second auxiliary rectifiers each generate a direct current (DC) output, and both DC outputs of the auxiliary rectifiers are connected to an auxiliary DC bus providing an auxiliary output for auxiliary devices. The main DC bus provides electric power for a plurality of inverters in operable connection with wheel motors for driving wheels of a vehicle during drive mode.

### BRIEF DESCRIPTION OF THE DRAWINGS

FIG. 1 shows a single-line diagram of a prior-art diesel-powered electrical system for a mining haul truck.

FIG. 2 shows a side view of a vehicle, for example a mining haul truck or a dump truck, in accordance with an exemplary embodiment of the present invention.

FIG. 3 shows a single-line diagram of a diesel-powered electrical system for a vehicle, in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of being electric drive systems and methods for mining applications. Embodiments of the present invention, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

In the description below, a vehicle, for example a mining haul truck or a dump truck is used as an example of electrically powered mining equipment. One skilled in the art, however, can develop embodiments of the invention for other electrically powered mining vehicles, such as front loaders, and for non-mobile electrically powered mining equipment, such as mills and conveyor systems.

FIG. 1 shows a single-line diagram of prior-art a mining haul truck power system 100. The mining haul truck has two drive wheels. In the drive mode, also referred to as the propel mode, each wheel is driven by a 3-phase alternating-current (AC) wheel motor (M). The wheel motors are referenced as a first wheel motor 110 and a second wheel motor 114. Electrical power is supplied by the diesel engine 102 driving the 3-phase AC generator 104, also referred to as an alternator. The diesel engine 102 and the generator 104 are connected via the coupling 124. Other types of engines can be used, but diesel engines are typical in mining operations. The diesel engine 102 and the generator 104 are mounted on the mining haul truck.

The AC output of the generator 104 is connected to the rectifiers 106. The direct current (DC) output of the rectifiers 106 is then connected to a single DC bus 126 with a positive rail 126A and a negative rail 126B. The inverter(s) 108 draw DC power from the DC bus 126 and supply 3-phase AC power to the wheel motor 110. Similarly, the inverter(s) 112 draw power from the DC bus 126 and supply 3-phase AC power to the wheel motor 114.

To slow down a moving mining haul truck, the mining haul truck drive system operates in the retard mode, also referred to as the braking mode. Under normal operation, an electrical motor converts electrical energy into mechanical energy. An electrical motor can also be operated in reverse as a generator to convert mechanical energy into electrical energy. The electrical energy is then fed into inverters. Braking choppers, connected to the inverters, channel the power into a power resistor grid that continuously dissipates the energy until the mining haul truck reaches standstill. Braking is smooth, without mechanical brake wear.

Referring to FIG. 1, the braking chopper 116 and the power resistor grid 118 dissipate energy from the wheel motor 110 during braking action, i.e. provide the braking action for the wheel motor 110. Similarly, the chopper 120 and the power resistor grid 122 dissipate energy from the wheel motor 114 during braking action. The mining haul truck can also be outfitted with a mechanical braking system as a backup to the electrical braking system.

In the power system shown in FIG. 1, the entire power requirements for the wheel motor 110 and the wheel motor 114 are supplied by the diesel engine 102.

Performance, as determined, for example, by acceleration and speed, of the mining haul truck is limited by the power capacity of the diesel engine 102.

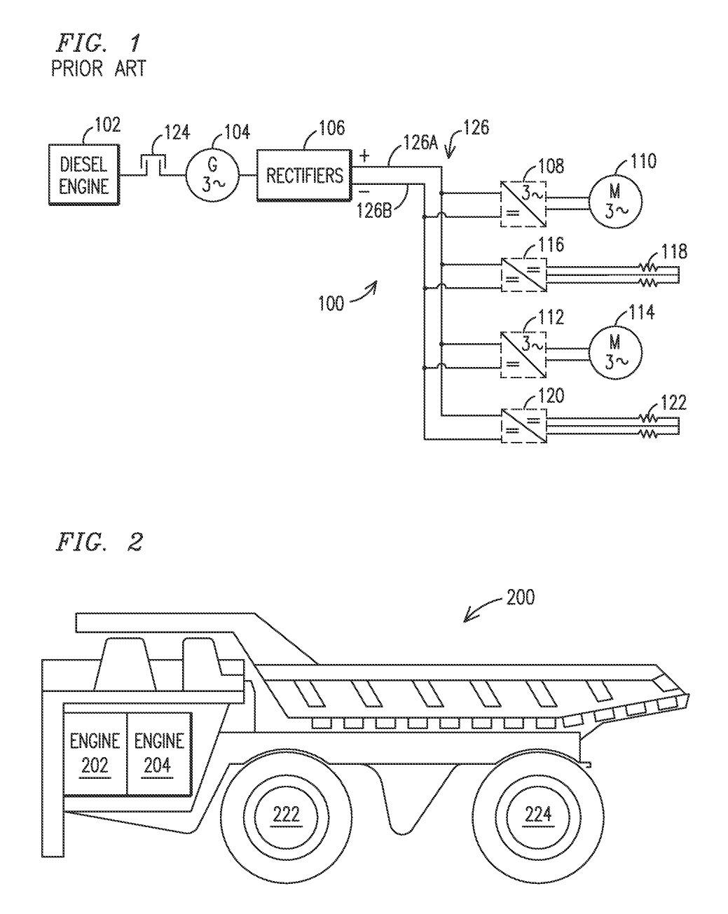

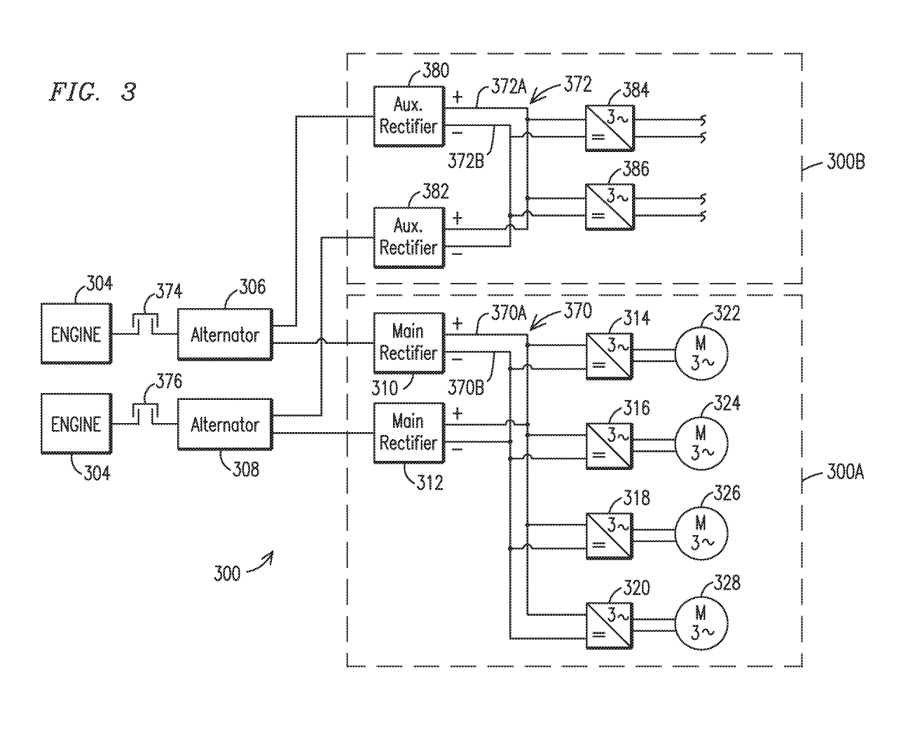

FIG. 2 shows a schematic representation of a side view of a vehicle, for example a mining haul truck or a dump truck, including components of a power system, in accordance with an exemplary embodiment of the present invention.

The vehicle 200, which can be for example a mining haul truck and in some embodiments, more specifically a dump truck, has at least two axles and up to four drive wheels, and can have, for example and not limiting, approximately a 450-metric ton payload capacity (those skilled in the art would appreciate different payload capacities are available). In the drive mode, each wheel is driven by a 3-phase alternating-current wheel motor, each motor coupled to a wheel of the mining haul truck. FIG. 2 shows electric wheel motors 222 and 224. The other two electric wheel motors are opposite the wheel motors 222 and 224 on the other side of the truck 200 (not shown in FIG. 2). Electrical power is supplied by two diesel engines 202, 204 driving two 3-phase AC generators, also referred to as alternators 206, 208. The first diesel engine 202 is coupled to the alternator 206, and the second diesel engine 204 is coupled to the alternator 208. The diesel engines 202, 204 and the alternators 206, 208 are mounted on the mining haul truck 200.

FIG. 3 shows a single-line diagram of a diesel-powered electrical system for a vehicle 200, in accordance with an exemplary embodiment of the present invention.

The drive system 300 comprises two diesel engines 302 and 304. Other types of engines may be used; diesel engines are typical in mining applications. Each diesel engine drives a 3-phase AC generator, also referred to as alternator. As illustrated in FIG. 3, the diesel engine 302 drives alternator 306, and the diesel engine 304 drives alternator 308. Each diesel engine 302, 304 is coupled to an alternator 306 and 308 via couplings 374 and 376. The diesel engines 302 and 304 and the alternators 306 and 308 are carried by the vehicle 200 (see FIG. 2), which can be for example a mining haul truck.

The alternators 306 and 308 can operate alone or in parallel. In an exemplary embodiment, each of the alternators 306 and 308 comprises a main winding and an auxiliary winding, also referred to as main field coil and auxiliary field coil. Each alternator field coil of each alternator 306 and 308 can be independently excited. Each AC output of the alternators 306 and 308 is connected to a rectifier. The AC output of the main winding of the alternator 306 is connected to main rectifier 310 and the AC output of the main winding of alternator 308 is connected to main rectifier 312. Both outputs of rectifiers 310, 312 are connected to a common DC bus 370. The DC bus 370 comprises a positive rail 370A and a negative rail 370B. Many types of rectifiers can be used. The rectifiers can comprise for example IGBTs or diodes. In an alternative embodiment, the common DC bus can comprise separate DC buses for each rectifier.

The drive system 300 comprises a plurality of inverters, for example four inverters 314, 316, 318 and 320 which draw DC power from the DC bus 370 and supply 3-phase AC power for up to four wheel motors 322, 324, 326, 328. This means that all four wheels of the mining haul truck have independent traction electric motors driven by two alternators 306 and 308 with two diesel engines 302 and 304. The inverters 314, 316, 318 and 320 can be for example IGBT inverters which provide a variable AC voltage to control the wheel motors 322, 324, 326, 328. The IGBT inverters feed the wheel motors 322, 324, 326, 328, and the speed of the mining haul truck varies in proportion to the IGBT inverter output frequency. Many other known types of inverters can be used for the described arrangement.

FIG. 3 shows the primary power system 300A and the auxiliary power system 300B using dotted lines. The rectifiers 310, 312, inverters 314, 316, 318, 320, and wheel motors 322, 324, 326, 328 are components of the primary power system 300A. The primary power system 300A can have many other components, for example braking choppers and resistors. Both engines 302, 304 and both alternators 306, 308 provide power to the paralleled DC links 370 and 372 of the primary system 300A and the auxiliary system 300B.

The auxiliary power system 300B as embodied according to FIG. 3 shows that each AC output of the auxiliary windings of the alternators 306 and 308 is connected to auxiliary rectifiers 380 and 382. For example, the AC output of the auxiliary winding of the alternator 306 is connected to auxiliary rectifier 380. The AC output of the auxiliary winding of alternator 308 is connected to auxiliary rectifier 382. Both rectifier outputs of auxiliary rectifiers 380 and 382 are connected to an auxiliary DC bus 372 comprising a positive rail 372A and a negative rail 372B.

The auxiliary power system 300B comprises a plurality of inverters for supplying power to auxiliary devices, for example cooling assemblies and retard functionality. In this example, the plurality of inverters comprises at least two inverters 384 and 386. The auxiliary power system 300B can comprise many components.

The drive system comprises four wheel motors, which allows front wheel and rear wheel drive. The drive system provides the ability to switch between front wheel and rear wheel drive, for example when the mining haul truck is not fully loaded. The use of the all-wheel gear has opened up new possibilities of distributing tractive effort to both axles of the mining truck. Also, having more than one power source allows partial machine operation in the event that one of the power sources fail. Further, in case of failure of one of the driving gears, an emergency mode can be activated, which would enable the truck to get to the service station without being towed.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

We claim:

1. Electric drive system for a vehicle comprising:
a first generator in communication with a first engine;
a second generator in communication with a second engine;
a first rectifier and a second rectifier;
wherein each generator comprises a main winding, each main winding being independently excitable and generating an alternating current (AC) output, a main AC output of the main winding of the first generator in communication with the first rectifier, and a main AC output of the main winding of the second generator in communication with the second rectifier,
wherein, when in drive mode, the first engine drives the first generator and the second engine drives the second generator, and the first and second generators supply power to a plurality of inverters coupled to the first and second rectifiers, the plurality of inverts supplying power to a plurality of electric wheel motors.

2. The electric drive system of claim 1, wherein the first and second rectifiers each comprise a direct current (DC) output, both DC outputs of the first and second rectifiers being connected to a main DC bus.

3. The electric drive system of claim 1, wherein each generator comprises an auxiliary winding, each auxiliary winding being independently excitable and generating an AC output.

4. The electric drive system of claim 3, wherein an auxiliary AC output of the auxiliary winding of the first generator is connected to a first auxiliary rectifier, and an auxiliary AC output of the auxiliary winding of the second generator is connected to a second auxiliary rectifier, both auxiliary rectifiers each comprising a direct current (DC) output, and both DC outputs of the auxiliary rectifiers being connected to an auxiliary DC bus.

5. The electric drive system of claim 2, wherein the plurality of inverters draws DC power from the main DC bus and supplies AC power to the plurality of electric wheel motors when in the drive mode.

6. The electric drive system of claim 2, wherein the main DC bus comprises separate DC busses for the first and second rectifiers.

7. Electric drive system of claim 1 configured to power a mining haul truck.

8. A method for providing electric power for a vehicle, the method comprising:
supplying electric power by at least two generators to at least four electric wheel motors, the at least two generators being in communication with at least two engines, wherein the electric power is supplied from a plurality of inverters for at least four electric wheel motors via at least two rectifiers, the at least two rectifiers being operably connected to the at least two generators.

9. The method of claim 8, wherein the at least two engines, the at least two generators and the at least four electric wheel motors are mounted on the vehicle.

10. The method of claim 8, wherein the at least four electric wheel motors are independently operable.

11. The method of claim 8, wherein the at least two generators are operated in parallel.

12. The method of claim 8, wherein outputs of the at least two generators are operably connected to the at least two rectifiers, the at least two rectifiers each comprising a direct current (DC) output, the DC output being connected to a main DC bus, and
wherein the outputs of the at least two generators are further operably connected to at least two auxiliary rectifiers, the at least two auxiliary rectifiers each comprising a direct current (DC) output, the DC output being connected to an auxiliary DC bus, the main DC bus and the auxiliary DC bus being operable in parallel.

13. The method of claim 8, wherein the vehicle is a mining haul truck.

14. An electric drive system comprising:
a first engine coupled to a first alternator, wherein the first alternator generates a first output and a second output;
a second engine coupled to a second alternator, wherein the second alternator generates a third output and a fourth output;
a first main rectifier operably connected to the first output of the first alternator;
a first auxiliary rectifier operably connected to the second output of the first alternator;
a second main rectifier operably connected to the third output of the second alternator;
a second auxiliary rectifier operably connected to the fourth output of the second alternator;
wherein the first and second main rectifiers each generate a direct current (DC) output, and both DC outputs of the main rectifiers are connected to a main DC bus, and
wherein the first and second auxiliary rectifiers each generate a direct current (DC) output, and both DC outputs of the auxiliary rectifiers are connected to an auxiliary DC bus providing an auxiliary output for auxiliary devices,
wherein the main DC bus provides electric power for a plurality of inverters in operable connection with wheel motors for driving wheels of a vehicle during drive mode.

15. The electric drive system of claim 14, wherein the main DC bus and the auxiliary DC bus are operable in parallel.

16. The electric drive system of claim 14, the plurality of inverters comprising a first inverter, a second inverter, a third inverter, and a fourth inverter,
wherein each inverter draws DC power from the main DC bus and generates an alternating current (AC) output for the wheel motors.

17. The electric drive system of claim 14 configured to power a mining haul truck.

18. The electric drive system of claim 17, wherein the first and second engines, the first and second alternators and the wheel motors are mounted on the mining haul truck.

19. The electric drive system of claim 14, wherein the wheel motors are independently operable.

20. The electric drive system of claim 14, wherein the first and second alternators are operated in parallel.
